(19) United States
(12) Patent Application Publication
(10) Pub. No.: US 2010/0004784 A1
(43) Pub. Date: Jan. 7, 2010

(54) Apparatus and method for effectively transmitting image through stereo vision processing in intelligent service robot system

(75) Inventors: Ji Ho Chang, Yongin (KR); Seung Min Choi, Daejeon (KR); Jae Il Cho, Daejeon (KR); Dae Hwan Hwang, Daejeon (KR)

Correspondence Address: Blakely, Sokoloff, Taylor & Zafman LLP, 1279 Oakmead Parkway, Sunnyvale, CA, 94085-4040, US

(73) Assignee: Electronics & Telecommunications Research Institute

(21) Appl. No.: 11/903,086

(22) Filed: Sep. 20, 2007

(30) Foreign Application Priority Data
Sep. 29, 2006 (KR) 2006-96569

(51) Int. Cl. G05B 15/00

(52) U.S. Cl. 700/259

(57) ABSTRACT

A data transmission apparatus of an intelligent robot system and a method thereof are provided. The data transmission apparatus includes a vision processor collector, a communicating unit, and a controller. The vision processor collects images captured through a camera, and performs an image process on the collected image to minimize a quantity of information about unnecessary regions in the collected image. The communicating unit communicates with the robot server, transmits the processed image data from the vision processor to the robot server, and receives corresponding result data from the robot server. The controller controls the image process and the transmission of the processed image data in the vision processor, and a corresponding operation of the robot terminal performed according to result data received from the robot server.

### CLAIM OF PRIORITY

This application claims the benefit of Korean Patent Application No. 2006-96569 filed on Sep. 29, 2006 in the Korean Intellectual Property Office, the disclosure of which is incorporated herein by reference.

### BACKGROUND OF THE INVENTION

1. Field of the Invention

The present invention relates to a method of transmitting data in an intelligent service robot system and, more particularly, to a data transmission apparatus of an intelligent robot system for effectively transmitting image information to a server using the stereo matching result of stereo image obtained by a robot, and a method thereof.

This work was supported by the IT R&D program of MIC/IITA[2005-S-033-02, Embedded Component Technology and Standardization for URC]

2. Description of the Related Art

In order to process image data obtained from a robot for face detection or face recognition, the computation capability of the high performance processor is required. Conventionally, following two methods have been used for performing such a process requiring the computation capability of the high performance processor, such as the face detection process or the face recognition process.

As the first method, a robot processes image data using a high performance computer. As the second method, image data captured in a robot is transmitted to a network server, and the network server processes the image data transmitted from the robot.

In the case of the first method, the size of the robot becomes enlarged, and the power consumption also increases. Therefore, it is difficult to apply the first method to a robot operated by battery power.

In the case of the second method, the image processing load of a robot can be reduced because the second method is applied to a network based terminal robot in which a network server performs complicated computation. Since the network based terminal robot simply compresses image data and transmits the compressed image data to the server, excessive communication traffic may be generated due to the image data transmission (upload) between the terminal robot and the server. Also, such excessive communication traffic makes the speed of a robot to response collected image data slower.

Generally, conventional image compression algorithms such as MPEG, and H.264 have been used to compress image data to transmit the image data from a robot to a server in a network based intelligent service robot system. Sine the conventional image compression algorithms compress unnecessary image regions such as background images included in image data as well as objects to be processed in a server, the compression efficiency thereof is degraded.

In a ubiquitous robot companion (URC) system, a server is connected to a plurality of intelligent robots through a network. In the URC system, it is required to reduce the load concentrated to the server by minimizing the quantity of image data transmitted to the server.

### SUMMARY OF THE INVENTION

The present invention has been made to solve the foregoing problems of the prior art and therefore an aspect of the present invention is to provide an apparatus and method for effectively transmitting data collected by a robot to a server in consideration of the load of a network in an intelligent service robot system.

Another aspect of the invention is to provide an apparatus and method for effectively transmitting image data collected by a terminal robot to a server while saving network resources for transmitting and receiving image data between a server and a terminal robot in an intelligent service robot system.

Still another aspect of the invention is to provide an apparatus and method for reducing the load of a network by minimizing the quantity of data to transmit to a server in a ubiquitous robot companion system (URC) in which one server is connected to a plurality of intelligent robots through a network and the server manages the intelligent robots.

According to an aspect of the invention, the invention provides a data transmission apparatus of an intelligent service robot system. The data transmission apparatus includes a vision processor for collecting images captured through a camera, and performing an image process on the collected image to minimize a quantity of information about unnecessary regions in the collected image, where the unnecessary regions are regions in the collected image that are unnecessary for performing an image process in a robot server that processes image data transmitted from a robot terminal in an ubiquitous robot system; a communicating unit for communicating with the robot server, transmitting the processed image data from the vision processor to the robot server, and receiving corresponding result data from the robot server; and a controller for controlling the image process and the transmission of the processed image data in the vision processor, and a corresponding operation of the robot terminal performed according to result data received from the robot server.

The vision processor may include: a camera unit for collecting image data captured through the camera; an input image preprocessor for performing an image preprocess on the collected image data from the camera through predetermined image processing schemes; an image postprocessor for creating a depth map by performing depth computation and depth extraction on the preprocessed image data, discriminating objects based on the created depth map, and extracting a horizontal and vertical size of a region including the discriminated objects and distance information from the robot terminal to a corresponding object; and an image output selector for determining image data of objects necessary at the robot server using information objected from the image postprocessor, sustaining image data about the determined objects, removing or simplifying image data of remained unnecessary objects, compressing the simplified image data, and outputting the compressed image data.

The camera unit may have a stereo camera having a left and right camera, which captures overlapped images for the same object using the left and right camera, and the input image preprocessor may perform an image preprocess on images captured from the stereo camera of the camera unit and outputs the preprocessed image data.

The vision processor may further include a stereo matching unit for finding a stereo matching region where images outputted from the input image preprocessor are correspondence one another, calculating a disparity map for the stereo matched object, and outputting the disparity map.

The image processing scheme of the image preprocess may include at least one of calibration, scale down filtering, rectification, and brightness control.

According to another aspect of the invention for realizing the object, the invention provides a method of transmitting data in an intelligent service robot system including: obtaining image data through left and right cameras of a stereo camera; extracting information about target objects included in the image data by performing a stereo vision process on the image data obtained through the left and right cameras; determining whether target objects to track are present in the stereo vision processed image data or not; setting objects corresponding to the target objects as an active region if the target objects are present in the stereo vision processed image data; matching a coordinate of a camera image with a result of stereo matching on the active region; changing image values of regions in the stereo vision processed image except the active region to meaningless data; and compressing entire image including the change image values and transmitting the compressed image to a robot server.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a network based intelligent service robot system using a vision processing apparatus of an network based intelligent service robot according to an embodiment of the present invention;

FIG. 2 is a block diagram illustrating an vision processing apparatus of a network based intelligent service robot according to an embodiment of the present invention;

FIG. 3 is a flowchart illustrating an effective image information transmission method using a vision processor of a network based intelligent service robot according to an embodiment of the present invention; and

FIG. 4 is a diagram illustrating an active region set by a robot vision processor according to an embodiment of the present invention.

### DETAILED DESCRIPTION OF THE PREFERRED EMBODIMENT

Exemplary embodiments of the present invention will now be described in detail with reference to the accompanying drawings. Like reference numerals denote like elements throughout accompanying drawings. Also, the detail description of well-known functions and configuration may be omitted in order to clearly describe the present invention.

Conventionally, apparatuses and methods for face detection, face recognition, or motion recognition based on images captured from a camera in a conventional network based service robot require a high performance processor and mass capacity memory. Thus, it is difficult for a mobile robot to perform such an operation. In general, a robot server performs most of the face detection, the face recognition, or the motion recognition. Since a server is connected to a plurality of robots in a ubiquitous robot system, it is required to reduce the quantity of data to transmit to the server. In order to overcome the problems of the conventional apparatus and method, an apparatus and method for saving network resources between a server and a terminal robot and reducing a vision processing load of a server connected to a plurality of robots are proposed. In order to save the network resources and reduce the vision processing load in the certain embodiment of the present invention, objects are recognized by a distance from a robot to the objects using three-dimensional information generated using stereo matching algorithm that can measure a distance between a robot and a target object. After recognition, the objects that are separated from the robot farther than a predetermined distance are determined as background. When the robot transmits image data to a server, the quantity of the image data is reduced by reducing the data of the areas determined as the background or transforming the areas determined as the background to block color, the reduced image data are compressed through various compression codec, and the compressed image data is transmitted to the server.

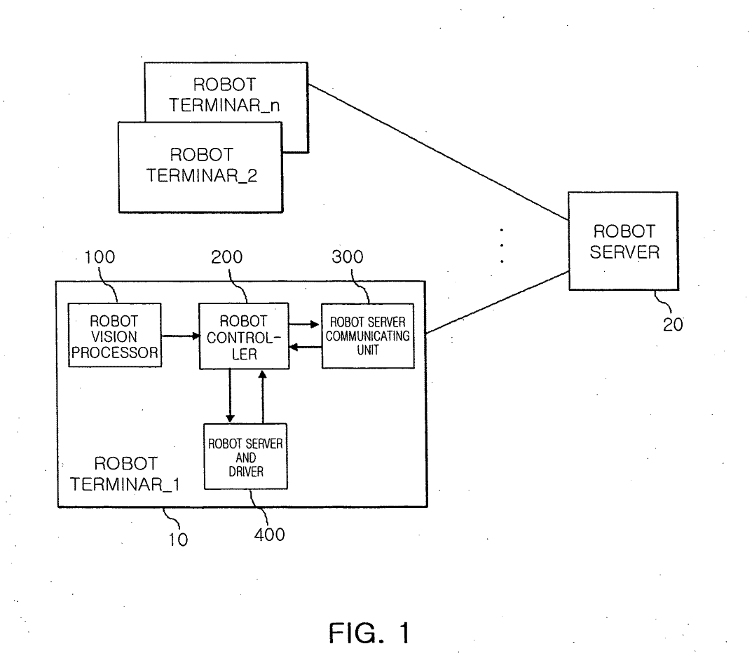

FIG. 1 is a block diagram illustrating a network based intelligent service robot system using a vision processing apparatus of an network based intelligent service robot according to an embodiment of the present invention

As shown, the network based robot system includes a robot server 20 and a plurality of robot terminals 10 interacting with the robot server 20. The shown network based robot system is a system for embodying a robot terminal 10 with comparatively low cost by concentrating application requiring complicated and large capacity process or a load requiring high speed computation, which cannot be performed in the robot terminal 10, to the robot server 20. Through the network based robot system, a user can receive various high quality services at a low cost.

The robot terminals 10 basically have the same configuration in a view of major feature. Representatively, the robot terminals 10 includes a robot vision processor 100, a robot sensor and driver 400, a robot server communicating unit 300, and a robot controller 200.

In order to reduce the cost thereof in the network based intelligent service robot 10, a cost of communication using a network must be reduced. In the case of Internet usage based charge system, it is better to reduce the quantity of communication between the robot terminal 10 and the robot server in a network based intelligent service robot application. Especially, the communication traffic between the robot server 20 and the robot terminals 10 is an important factor influencing not only to a communication cost but also to system stability because the plurality of robot terminals 10 interact with the one robot server 20 as shown in FIG. 1.

A method of driving a vision processor 100 of a network based intelligent service robot according to the present embodiment is proposed for optimizing image data that mostly occupies traffics between the robot terminals 10 to the robot server 20 without requiring a high cost robot terminal.

In general, the robot terminal 10 captures images using a camera, compresses the entire captured images, and transmits the compressed images to the robot server 20 in order to drive the robot terminal 10 in the network based intelligent service robot system. Then, the robot server 20 processes image data for object recognition, face detection, and face recognition to enable the robot terminal 10 to provide various services to a user. In the certain embodiment of the present invention, a device for improving the image compression efficiency is disposed in the robot terminal 10 to significantly reduce the quantity image data from the result of a stereo vision system except necessary parts in the robot server 20. Therefore, the amount of traffic between the robot terminal 10 and the robot server 20 is significantly reduced.

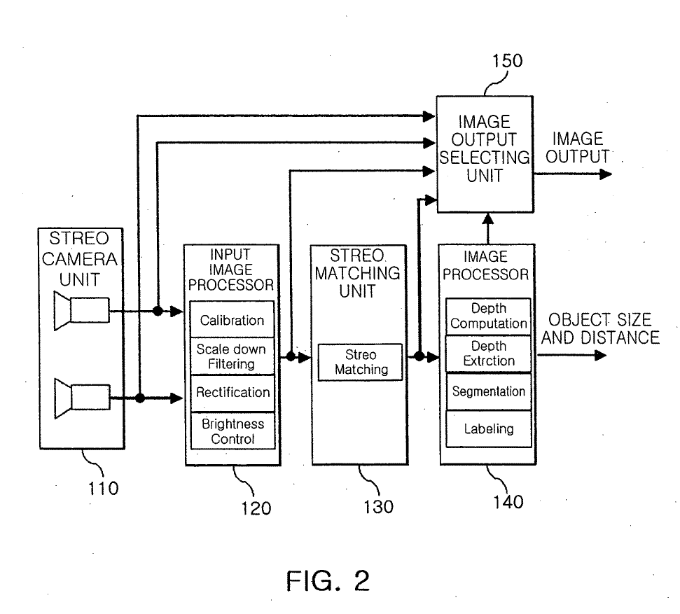

FIG. 2 is a block diagram illustrating an vision processing apparatus of a network based intelligent service robot according to an embodiment of the present invention.

As shown in FIG. 2, the vision processor 100 of the network based intelligent service robot includes a stereo camera unit 110, an input image preprocessor 120, a stereo matching unit 130, an image postprocessor 140, and an image output selecting unit 150.

In FIG. 2, the stereo camera unit 110 captures mages from two cameras, left and right cameras.

The input image preprocessor 120 processes the images inputted from the cameras of the stereo camera unit 110 through various image processing scheme in order to enable the stereo matching unit 130 to easily perform the stereo matching, thereby improving overall performance. For example, the processed image outputted from the image preprocessor 120 is calibrated. The image processing schemes of the input image preprocessor 120 includes calibration, scale down filtering, rectification, and brightness control.

The stereo matching unit 130 performs the stereo matching by finding corresponding areas from left and right images calibrated from the input image preprocessor 120 and calculates a disparity map based on the result of the stereo matching. For example, the image outputted from the stereo matching unit 130 is an image expressing distance information of objects in bright color (close objects) and dark color (distant object).

The image postprocessor 140 extracts a depth map through depth computation and depth extraction based on the disparity map from the stereo matching unit 130. Herein, the image post processor 140 performs segmentation and labeling for discriminating different objects from the extracted depth map. For example, the outputted image from the image postprocessor 140 is an image expressing the shapes of objects. Meanwhile, after discriminating the objects included in the extracted depth map, the image postprocessor 140 extracts a horizontal and vertical size of a corresponding object and a distance from the robot terminal 10 to the corresponding object from the post-processed image.

The image output selector 150 selects image data of objects required in the robot server 20 using finally obtained information from the image postprocessor 140. After selecting the image data of objects required in the robot server 20, the image output selector 150 sustains the selected image data of required object and removes or simplifies image data of unnecessary objects in order to compress image data with high efficiency. Finally, the image output selector 15 compresses image data using a predetermined image compressing scheme such as MPEG, H.264, or JPEG before transmitting the image data to the robot server 20.

Then, the robot controller 200 of the robot terminal transmits the compressed image data to the robot server 20 through the robot server communicating unit 300.

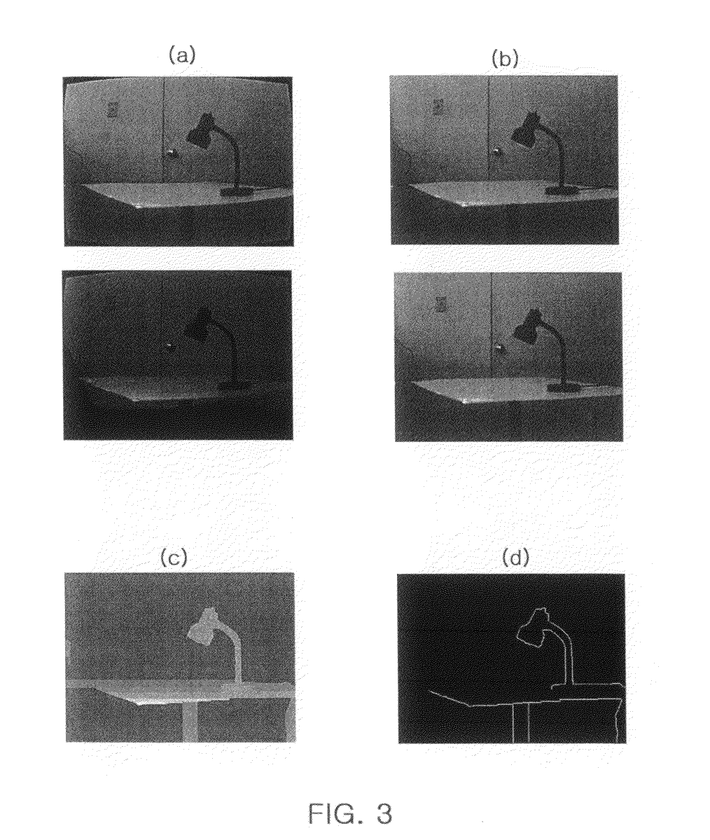

FIG. 3 is a flowchart illustrating an effective image information transmission method using a vision processor of a network based intelligent service robot according to an embodiment of the present invention.

As shown in FIG. 3, the robot vision processor 100 captures images from the left and right cameras of the stereo camera unit 110 at step S110. The robot vision processor 100 performs a stereo vision process on the image data obtained from the left and right cameras by performing the image preprocess, the stereo matching, and the image post process at step S120. For example, a ‘Falcon H/W Chip’ may be used for image processing.

The robot vision processor 100 determines whether a target object to track (obj_num) is present in the stereo vision processed image data or not at step S130.

If the robot vision processor 100 determines that a target object to track (obj_num) is present in the stereo vision processed image data, the robot vision processor 100 sets an object corresponding to the target object as an active region at step S150. On the contrary, if not, the robot vision processor 100 sets all objects as an active region except a background at step S140.

The robot vision processor 100 matches the result of stereo matching for the activated regions with the coordinates of the camera image at step S160. The robot vision processor 100 changes the image values of the set active region to the black color (0) at step S170. Accordingly, the robot vision processor 100 compresses the transformed entire image and transmits the compressed image to the robot server 20 at step S180.

Meanwhile, the robot server 20 performs a corresponding image process algorithm using images transmitted from the robot terminal 10 having the robot vision processor 100 at step S2.10. Afterward, the robot server 20 sets a next target object to track in the robot terminal 10 at step S220. Accordingly, the robot server 20 transmits information about the set target object and the coordinate information thereof to the robot terminal 10 at step S230.

After the robot terminal 10 receives the target object information and the coordinate information thereof from the robot server 20, the robot terminal 10 performs the steps S130 to S180.

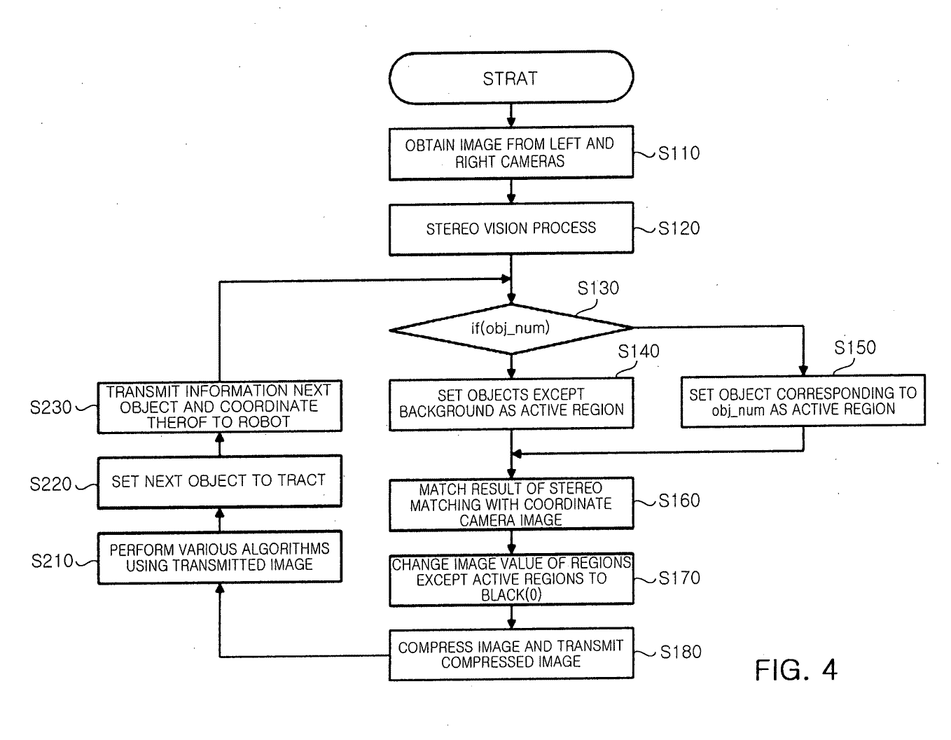

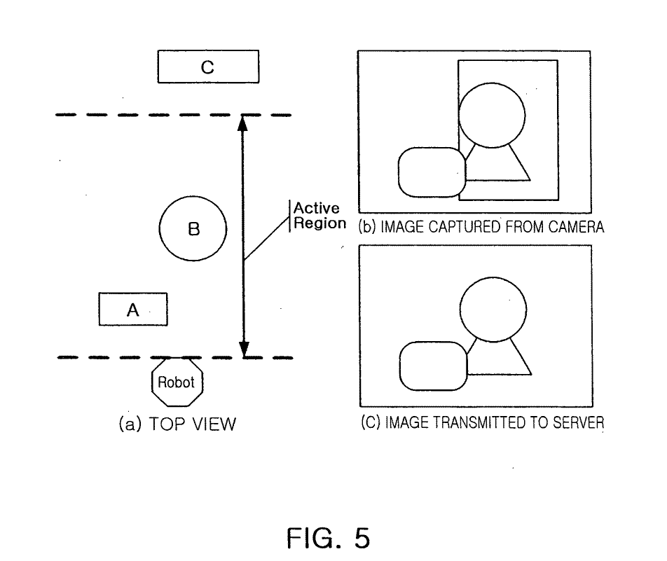

FIG. 4 is a diagram illustrating an active region set by a robot vision processor according to an embodiment of the present invention.

A diagram (a) of FIG. 4 is a top view of a region to photograph by the robot terminal 10. As shown, objects A, B, and C are present according to distances from the robot terminal 10.

Herein, a diagram (b) of FIG. 5 shows the image captured through the camera of the robot terminal 10. As shown, the captured image in (b) of FIG. 5 includes a background image collected through the lens of the camera as well as objects A and B.

The robot vision processor 100 selects an active region of the objects A and B from the image with the background image like as (b) of FIG. 4 so as to select an image to transmit to the robot server 20 like as a diagram (c) of FIG. 4. Herein, the robot vision processor 100 fills up with the remained space of the captured image excepting the activate regions of the objects A and B with values 0(black) and 255(white). The black and white values ‘0’ and ‘255’ will be removed through an image compressing process performed by the robot vision processor 100 before transmission.

As set forth above, unnecessary image data for image-processing in the robot server is reduced and the quantity of data to transmit to the robot server based on distance information obtained using low cost stereo camera and dedicated chip embedded internal hardware before transmitting the image data to the robot server in the network based intelligent robot system according to certain embodiments of the invention. Therefore, the excessive network traffic in an ubiquitous robot system and the computation load of the server connected to robots can be reduced.

While the present invention has been shown and described in connection with the preferred embodiments, it will be apparent to those skilled in the art that modifications and variations can be made without departing from the spirit and scope of the invention as defined by the appended claims.

What is claimed is:

1. A data transmission apparatus of an intelligent service robot system comprising:
a vision processor for collecting images captured through a camera, and performing an image process on the collected image to minimize a quantity of information about unnecessary regions in the collected image, where the unnecessary regions are regions in the collected image that are unnecessary for performing an image process in a robot server that processes image data transmitted from a robot terminal in an ubiquitous robot system;
a communicating unit for communicating with the robot server, transmitting the processed image data from the vision processor to the robot server, and receiving corresponding result data from the robot server; and
a controller for controlling the image process and the transmission of the processed image data in the vision processor, and a corresponding operation of the robot terminal performed according to result data received from the robot server.

2. The data transmission apparatus according to claim 1, wherein the vision processor includes:
a camera unit for collecting image data captured through the camera;
an input image preprocessor for performing an image preprocess on the collected image data from the camera through predetermined image processing schemes;
an image postprocessor for creating a depth map by performing depth computation and depth extraction on the preprocessed image data, discriminating objects based on the created depth map, and extracting a horizontal and vertical size of a region including the discriminated objects and distance information from the robot terminal to a corresponding object; and
an image output selector for determining image data of objects necessary at the robot server using information objected from the image postprocessor, sustaining image data about the determined objects, removing or simplifying image data of remained unnecessary objects, compressing the simplified image data, and outputting the compressed image data.

3. The data transmission apparatus according to claim 2, wherein the camera unit has a stereo camera having a left and right camera, which captures overlapped images for the same object using the left and right camera.

4. The data transmission apparatus according to claim 3, wherein the input image preprocessor performs an image preprocess on images captured from the stereo camera of the camera unit and outputs the preprocessed image data.

5. The data transmission apparatus according to claim 4, wherein the vision processor further includes a stereo matching unit for finding a stereo matching region where images outputted from the input image preprocessor are correspondence one another, calculating a disparity map for the stereo matched object, and outputting the disparity map.

6. The data transmission apparatus according to claim 4, wherein the image processing scheme of the image preprocess includes at least one of calibration, scale down filtering, rectification, and brightness control.

7. A method of transmitting data in an intelligent service robot system comprising:
obtaining image data through left and right cameras of a stereo camera;
extracting information about target objects included in the image data by performing a stereo vision process on the image data obtained through the left and right cameras;
determining whether target objects to track are present in the stereo vision processed image data or not;
setting objects corresponding to the target objects as an active region if the target objects are present in the stereo vision processed image data;
matching a coordinate of a camera image with a result of stereo matching on the active region;
changing image values of regions in the stereo vision processed image except the active region to meaningless data; and
compressing entire image including the change image values and transmitting the compressed image to a robot server.

8. The method according to claim 7, wherein an image value of the meaningless data is one of block (0) and white (255).

9. The method according to claim 7, further comprising setting an image of objects without background among the image data as an active region if no object to track is present in the step of determining.

10. The method according to claim 7, wherein the stereo vision process includes an image preprocess, a stereo matching process, and an image postprocess.

11. The method according to claim 10, wherein the image processing scheme of the image preprocess includes at least one of calibration, scale down filtering, rectification, and brightness control.
